(19) United States
(12) Patent Application Publication
(10) Pub. No.: US 2010/0218090 A1
(43) Pub. Date: Aug. 26, 2010

(54) SUB-PAGE-BASED PAGE LAYOUT SYSTEM AND METHOD THEREOF

(75) Inventors: Aviel Amit, Holon (IL); Adi Gotshal, Givataim (IL); Itamar Avraham, Ramat-Gan (IL)

Correspondence Address: MYERS WOLIN, LLC, 100 HEADQUARTERS PLAZA, North Tower, 6th Floor, MORRISTOWN, NJ, 07960-6834, US

(73) Assignee: Universal - Ad Ltd., Bnei-Brak (IL)

(21) Appl. No.: 12/393,098

(22) Filed: Feb. 26, 2009

(51) Int. Cl. G06F 17/00

(52) U.S. Cl. 715/247; 715/253

(57) ABSTRACT

A method for automatically laying out a page comprises defining a page body area for the page and a page internal grid for the page body area; positioning a plurality of sub-pages on the page body area according to the page internal grid; for each sub-page of the plurality of sub-pages defining a sub-page body area for the sub-page and a sub-page internal grid for the sub-page body area, wherein the sub-page internal grid defined for each sub-page and the page internal grid enable to layout the each sub-page independently of the page; and positioning at least one graphical element on the sub-page body area according to the sub-page internal grid.

### TECHNICAL FIELD

This invention generally relates to page layout systems and methods.

### BACKGROUND OF THE INVENTION

Commercially printed publications, such as retail advertisements (ads), are delivered weekly to millions of households across the USA. The retail ads present promotional information about various products for sale at a retail chain. For example, promotional information may include discounted prices of products, buy-one-get-one sales, coupons, and so on. Typically, retail ads are divided into sections, each of which displays promotional information related to a particular ad-department. The promotions advertised in each ad-department and the space allocated to such promotions are typically determined by the retailer's merchandising and marketing teams. In addition, stores in different locations may promote different products or different prices for the same products. Retail ads are typically produced in different formats by a retailer's advertising team. This team is usually responsible to produce pages of retail ads (“ad pages”) by designing the layout and appearance of each of the ad pages.

Designers of the advertising team typically utilize grid-based page layouts for this purpose, and use different parameters such as grids, typefaces, and color schemes to differentiate the look and feel of different ad departments. For example, one grid with a brown set of colors may be used for the promotions of the bakery department and on the same page, another grid with a blue set of colors may be used for promoting the products of the frozen foods department. The space allocated to the different grids may also be different. A newspaper magazine layout is another example for using different types of grids on the same page, where one grid is a used for the economic section and another grid is a used for advertising.

Typically, a designer uses page layout software and predefined layout templates to layout the pages of a retail ads. With this aim, the designer allocates space to each department on a page; determines the size and the grid for that department, the position of that grid within pages, the size of the gutter between grids, and so on. In most cases, the designer has to select or edit colors, select compose and position images, and key in, style and position text according to predefined specific creative rules and templates for that department as pre-set by an art director. In many cases due to errors, last minute changes, ad hoc grid changes and time constraints the designer compromises some of the creative rules. As a result, the page may end improperly aligned, with unaesthetic layouts and with look-and-feel that does not always conform with the brand creative rules. Examples for retail ads designed using conventional grid-base page layout systems are provided in FIGS. 1A and 1B. The circled sections are grids that are misaligned.

Another disadvantage of the above mentioned so called manual design process is that different layouts and designs need to be re-created for different promotional information due to the growing need for more targeted and cross media campaigns. For example, different layouts need to be generated for different stores of the same chain having different prices or products for some of the products on sale. This is a costly and time consuming approach.

It would be therefore advantageous to provide an automated solution for page layout of a page including a large number of internal grids, color schemes and creative rules.

### SUMMARY OF THE INVENTION

Certain embodiments of the invention include a method for automatically laying out a page. The method comprises defining a page body area for the page and a page internal grid for the page body area; positioning a plurality of sub-pages on the page body area according to the page internal grid; for each sub-page of the plurality of sub-pages defining a sub-page body area for the sub-page and a sub-page internal grid for the sub-page body area, wherein the sub-page internal grid defined for each sub-page and the page internal grid enable to layout the each sub-page independently of the page; and positioning at least one graphical element on the sub-page body area according to the sub-page internal grid.

Certain embodiments of the invention also include computer readable medium having stored thereon computer executable code causing a computer to execute a process of automatically laying out a page. The process comprises defining a page body area for the page and a page internal grid for the page body area; positioning a plurality of sub-pages on the page body area according to the page internal grid; for each sub-page of the plurality of sub-pages defining a sub-page body area for the sub-page and a sub-page internal grid for the sub-page body area, wherein the sub-page internal grid defined for each sub-page and the page internal grid enable to layout the each sub-page independently of the page; and positioning at least one graphical element on the sub-page body area according to the sub-page internal grid.

Certain embodiments of the invention further include a system for automatically laying out a page. The system comprises a memory for saving design settings; a storage device for storing at least content units; a graphical user interface for providing layout views; and a processor for executing the process of automatically laying out a page, wherein the process comprising: defining a page body area for the page and a page internal grid for the page body area; positioning a plurality of sub-pages on the page body area according to the page internal grid; for each sub-page of the plurality of sub-pages defining a sub-page body area for the sub-page and a sub-page internal grid for the sub-page body area, wherein the sub-page internal grid defined for each sub-page and the page internal grid enable to layout the each sub-page independently of the page; and positioning at least one graphical element on the sub-page body area according to the sub-page internal grid.

### BRIEF DESCRIPTION OF THE DRAWINGS

The subject matter that is regarded as the invention is particularly pointed out and distinctly claimed in the claims at the conclusion of the specification. The foregoing and other objects, features and advantages of the invention will be apparent from the following detailed description taken in conjunction with the accompanying drawings.

FIGS. 1A and 1B are examples of retail ads generated using conventional grid-based page layouts system.

FIGS. 2A, 2B and 2C are exemplary page layouts constructed in accordance with certain embodiments of the invention.

FIG. 3 is an exemplary page layout of a retail ad constructed in accordance with the invention.

FIG. 4 is a flowchart describing a sub-page based page layout method implemented in accordance with an embodiment of the invention.

FIG. 5 is a block diagram of a system capable of automatically generating a sub-page based page layout operative in accordance with certain embodiments of the invention.

FIGS. 6A, 6B, 6C and 6D are exemplary screenshots of a GUI operative in accordance with certain embodiments of the invention.

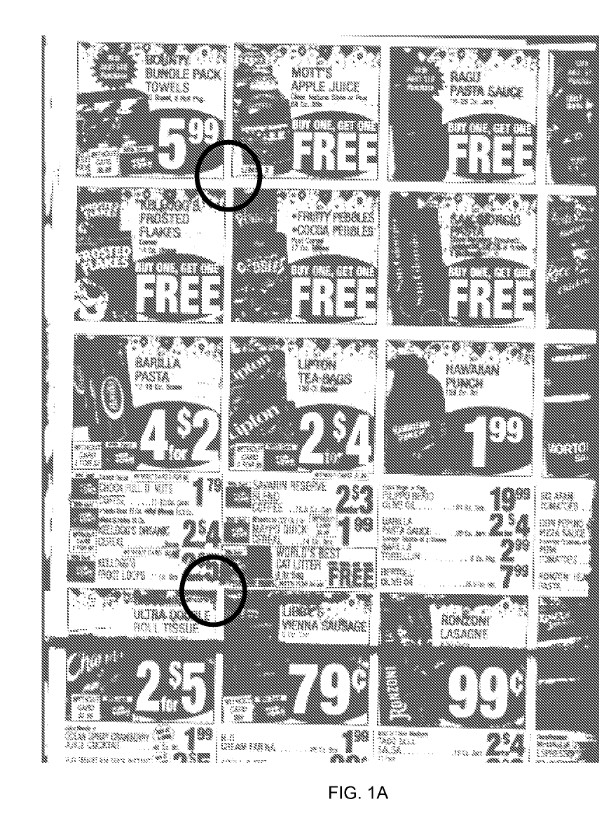

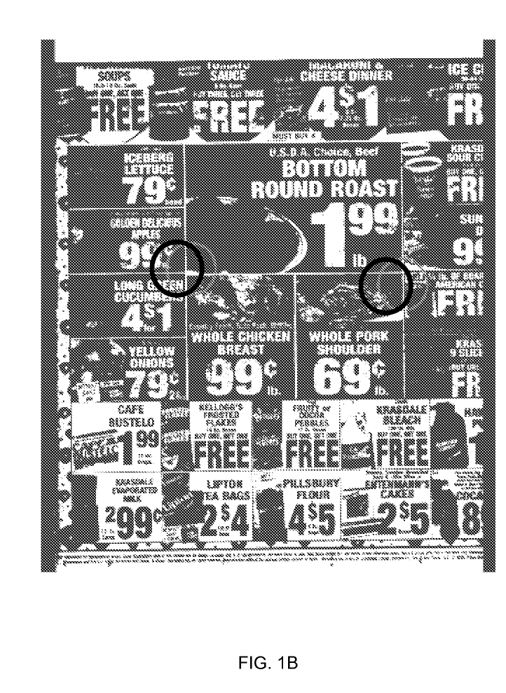

### DETAILED DESCRIPTION OF THE INVENTION

It is important to note that the embodiments disclosed are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

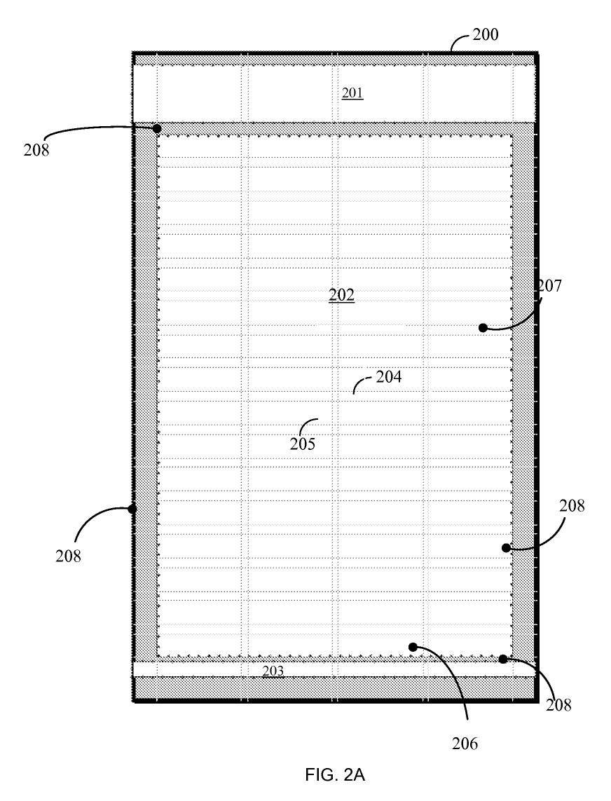

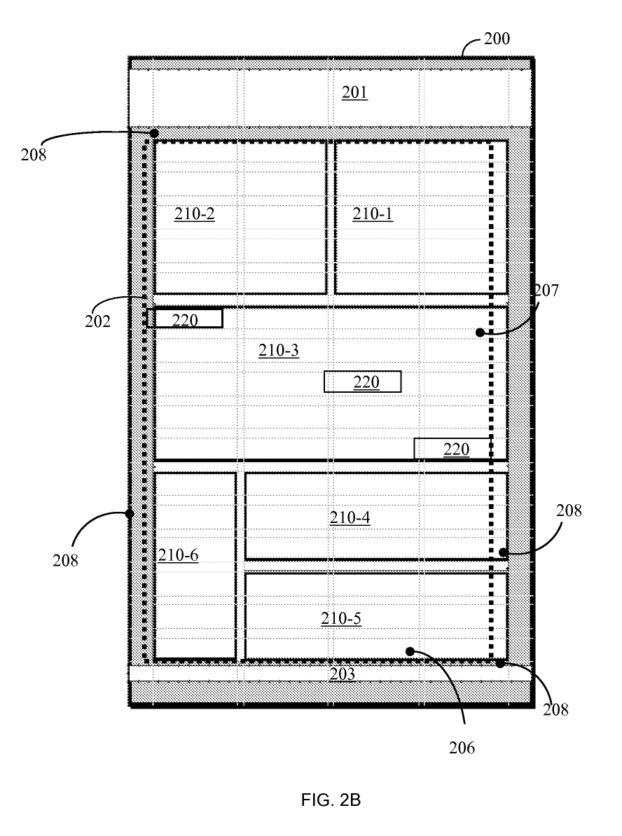

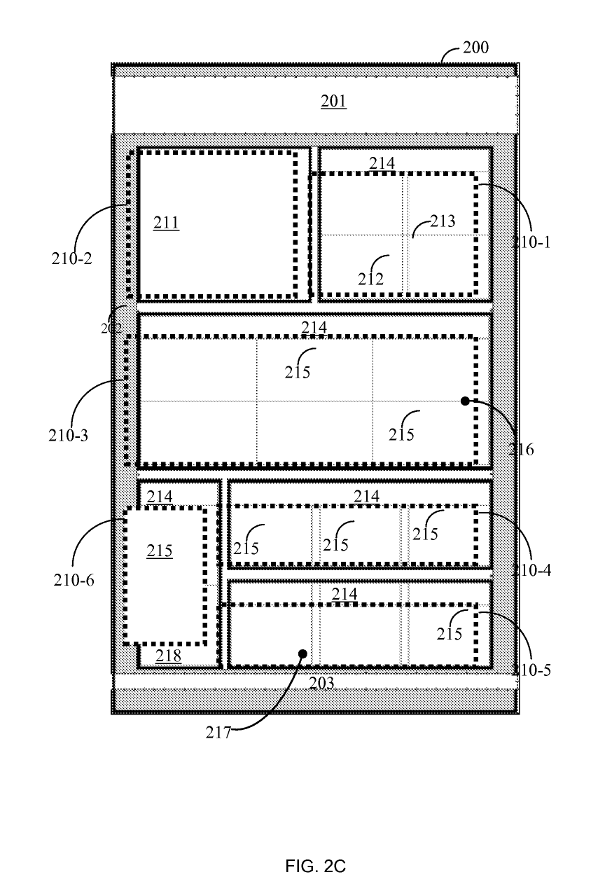

To overcome the drawbacks of a manual grid-based page layout system, a method for automatically laying out a page having a plurality of sub-pages is provided. FIGS. 2A, 2B and 2C show exemplary page layouts constructed in accordance with certain embodiments of the invention. As depicted in FIG. 2A, a typical page 200 includes (within its boundaries) the following elements: a header area 201, a body area 202, a footer area 203, and a margins area 208 (i.e., a top margin, a bottom margin, a left margin, and a right margin). The body area 202 of the page 200 is virtually divided into a plurality of rows 204 and columns 205, where the space between two columns is determined by a column gutter 206, and the space between two rows is determined by row gutter 207.

In accordance with the principles of the invention, the body area 202 of the page 200 includes at least one sub-page generally related to as 210. As illustrated in FIG. 2B, the body area 202 (the boundaries of which are illustrated using a dotted line) of the page 200 is divided into a number of six separated areas for sub-pages 210-1 through 210-6, each of which spans on one or more rows 204 including the row gutter 207 between these rows and also spans on one or more columns 205 including the column gutter 206 in between these columns.

Specifically, each sub-page 210 is defined using the following attributes: a sub-page boundary, a sub-page width (in terms of the number of page grid columns), a sub-page height (in terms of number of page grid rows), a sub-page reference point 220 (in terms of sub-page row position number on the page grid), and a sub-page column position number on the page grid. As can be noticed the subpages 210 may have a different or a same size (i.e., height and width). The reference point may be either of a top left corner, a bottom right corner, a center of the sub-page, and so on.

It should be noted that the space allocated for a sub-page may overlap with other sub-page(s). It should be further noted that elements of a sub-page can be optionally laid out partially or fully outside of the sub-page's boundaries.

As shown in FIG. 2C, a sub-page 210 has a body 211 marked with dotted line that includes the following elements: internal grid defined by internal rows 212 and columns 213. The space between the rows 212 and the space between the columns 213 is determined respectively according to their row gutter 216 value and column gutter 217 value (both of which may be set to zero). A sub-page 210 may also include a sub-page header 214 and/or a sub-page footer 218. It should be noted that these internal elements can be independently defined for each sub-page 210, thus each sub-page 210 may have different layout. It should be further noted that the internal elements of a sub-page 210 can be defined independently of the elements of the page 200. That is, the row gutter, column gutter, number of rows, number of columns, boundaries, headers and footers defined for a page 200 may be different from those defined for a sub-page 210. Therefore, in accordance with the invention a sub-page layout can be different from a page layout and a sub-page can be designed independently of a page. Furthermore, the structure of a sub-page layout ensures that the sub-page's graphical content can optionally be aligned within the sub-page and with its adjacent sub-pages.

The elements of a page 200 and a sub-page 210 can be optionally assigned with at least one of resizing rules, look-and-feel (or creative) rules, repurposing rules, and content rules. The resizing rules define how to independently resize and reposition the elements of a page and/or subpage, under certain changes of the page size or of the sub page size. The look-and-feel rules include, for example, graphic and typographic styles, that define how the page and/or sub-page elements will look like. The content rules define what content will be placed in each page, sub-page, and their respective elements, thereby enabling automatically assigning content from content databases onto pages and sub pages elements, layout these elements, and style these elements and their content. The repurposing rules may define for each media type, a file format, a list of look-and-feel rules, content grouping rule, content selection rules, pagination rules, grid rules, and resize rules. In some cases the repurposing rules may dictate the use of the same content, look-and-feel, under different pagination, or different grid, size, and file format as the case may be.

In accordance with one embodiment of the invention content rules assigned for a sub-page or a page corresponding to one media type can be automatically applied with some modifications to other types of media. This is particular useful in cases where there is a need to create retail ads in multiple different media types. Examples for such media types include a print page, a web page, a page displayed over a mobile device, a signage, and so on. In another embodiment one or more interaction rules can be assigned to a page and/or a sub-page and/or a graphical element. Such rules include, for example, hyperlinks, buttons, or any other user interface controls that can be added to one or more elements of a page and/or a sub-page and/or a Graphical Element in order to enable interaction through an external input (e.g., a page created for a mobile device or web).

In accordance with the principles of the invention, a cell 215 of a sub-page 210 includes graphical content in the form of text, images and other graphical elements or any combination thereof (collectively referred to hereinafter as “Graphical Element”). A Graphical element is placed in one or more cells 215, while its position is defined by a sub-page grid row number, a sub-page column number. The Graphical Element's size is defined by its width in terms of sub-page columns, its height in terms of sub-page rows, and the column and row gutters in between its columns and its rows respectively. For example, as shown in FIG. 2C, the sub-page 210-3 includes six cells while sub-page 210-6 includes only one cell. All Graphical Elements to be placed in a single sub-page are considered as the content of that sub page.

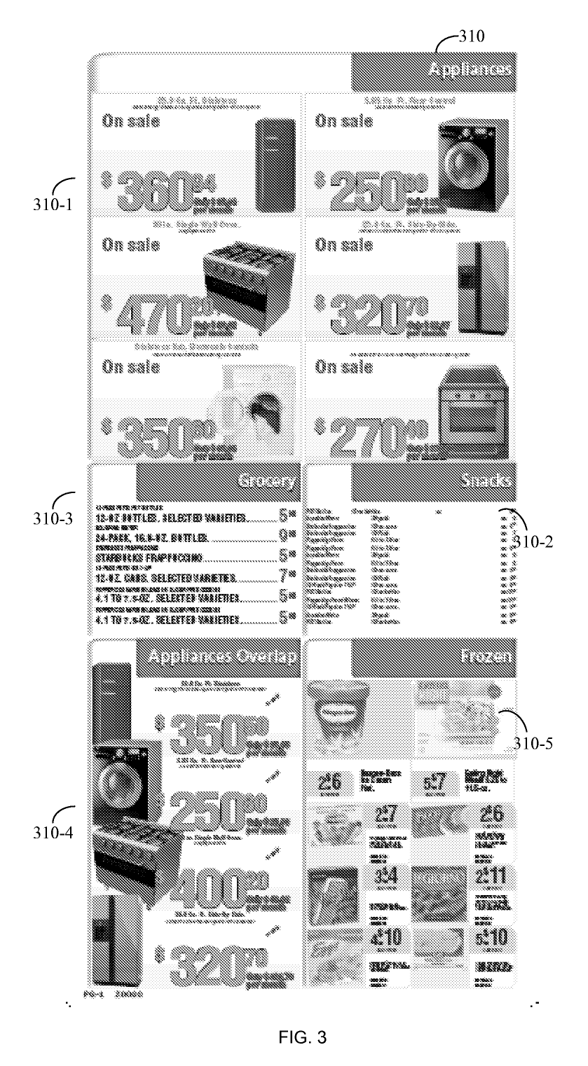

It would be appreciated by one of ordinary skill in the art that the sub-page based page layout can be efficiently utilized for the designing of at least retail ads, where different space is allocated to different products and/or departments and/or group of products. FIG. 3 shows an exemplary layout of a retail ad page 310 constructed in accordance with the invention. The page 310 includes five sub-pages 310-1 through 310-5, each of which includes promotional information for a different department. The header of each sub-page 310 includes the name of the department, while the cells in each sub-page include the Graphical Elements. For example, the sub-page 310-1 includes six Graphical Elements each displaying an image of an appliance, its price its description and other promotional information. As can be noted the Graphical Elements are perfectly aligned within each a sub-page and across sub-pages.

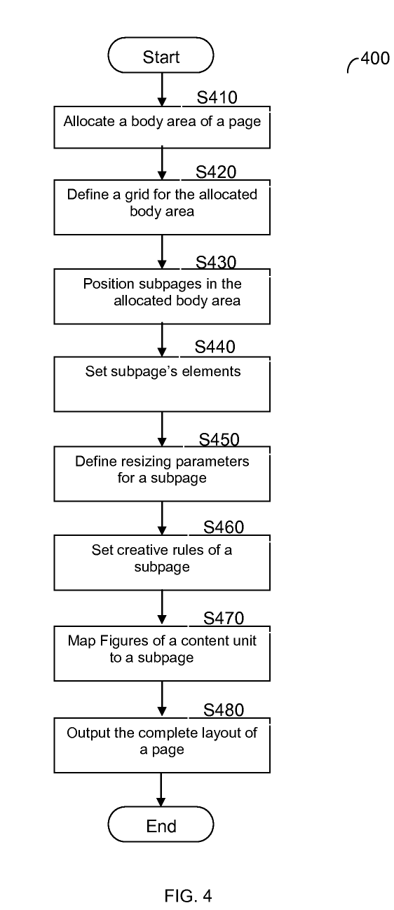

FIG. 4 shows a non-limiting and exemplary flowchart 400 describing the sub-page based page layout method implemented in accordance with an embodiment of the invention. At S410, a body area of a page is allocated for placing one or more sub-pages. That is, a user (e.g., a graphic designer) determines the size of a page body (e.g., body area 202) and whether the page includes a header and/or footer. The number of sub-pages to be included in the page is determined according to the number of product groups or department to be placed on that page and the number of Graphical Elements of each sub-page. At S420, a grid for the allocated page body area is defined by setting at least the number of columns and rows within this page body area, the width of column gutter and the height of row gutter. As an example, the outcome of step S420 is as illustrated in FIG. 2A. At S430, the position of each sub-page within the allocated page body area is determined by specifying the column and row number in the page grid where a reference point 220 for the sub-page should be placed and the number of rows and columns that the sub-page will span on the page body area grid. The reference point 220 may be, for example, a top left corner, a bottom right corner, a center of the sub-page, and so on.

At S440, elements for each sub-page that is positioned in the allocated body area are determined. The elements may include, but are not limited to, boundaries of the sub-page (defined in terms of number of rows and columns the sub-page spans on), header and footer attributes, sub-page body area, number of internal grid rows, number of internal grid columns, height of the gutters between the rows of the internal grid, and width of gutters between the columns of the internal grid. The boundaries of a sub-page are always within the allocated body area of the page. As mentioned above, a sub-page may overlap with other sub-page(s) and in addition its internal elements may exceed the boundaries of the sub-page. However, all sub-page elements are defined regardless of the page elements. That is, the number of internal rows and columns and their respective gutters can be different from the number of rows, columns and gutters defined for the page. In addition, a page may include a header even if one or more of its sub-pages does not. The outcome of step S440 is illustrated in FIG. 2C. In accordance with an embodiment of the invention internal grids and the area allocated for each sub-page is determined according to the number of Graphical Elements to be placed in the sub-page and the properties set for the sub-page's elements.

Optionally, at S450, resizing and repositioning rules are defined for each sub-page. These parameters enable the optimization of the space allocated for each sub-page and further the optimization of the arrangement of such sub-pages. An example for such a process may be found in a U.S. application Ser. No. 10/260,085 filed on Oct. 28, 2005, the contents of which are herein incorporated by reference.

At S460 the creative rules for each of the sub-pages are set. These rules include, but are not limited to, the type, font, size, background and color of the various graphical elements, such as the header, footer and body. It should be noted that the creative rules set for a sub-page are not the Graphical Elements. For example, as shown in FIG. 3 in the “Appliances sub-page”, the prices of all products are shown using the same font size, color and type as determined by the creative rules set for this sub-page, while the Graphical Elements are the appliances' pictures their description and prices. At S470, Graphical Elements of a content unit are automatically mapped to internal cells of a sub-page. At S480, a page layout is output and displayed to the user. An exemplary page layout generated by the method disclosed herein is provided in FIG. 3. It should be noted that the steps described herein can be performed in a different order or in parallel.

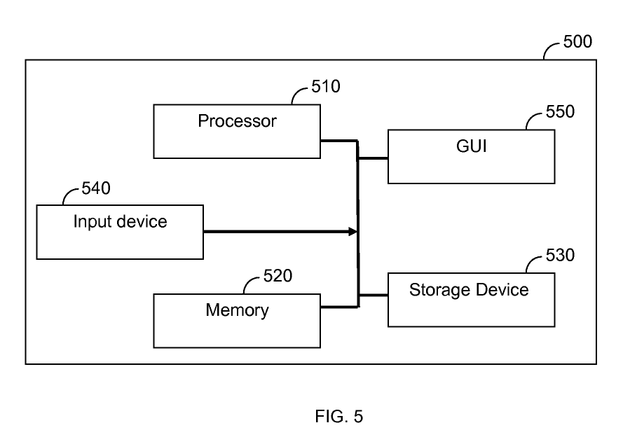

FIG. 5 shows a non-limiting and exemplary block diagram of a system 500 capable of automatically generating a sub-page-based page layout operative in accordance with an embodiment of the invention. The system 500 includes a processor 510, a memory 520, a storage device 530, an input device 540, and a graphic user interface (GUI) 550. The processer 510 is adapted to automatically generate a page layout including at least one sub-page based on the sub-page's elements and the creative rules as defined by a user. The user's settings are input using the input device 540 and are saved in the memory 520. The memory 520 may be any type of non-volatile computer memory, e.g., Flash, EEPROM, and the like or any type of volatile computer memory, such as RAM, DRAM, and the like. The storage device 530 maintains saved page layouts and Graphical Elements arranged in content units as uploaded by the system's users.

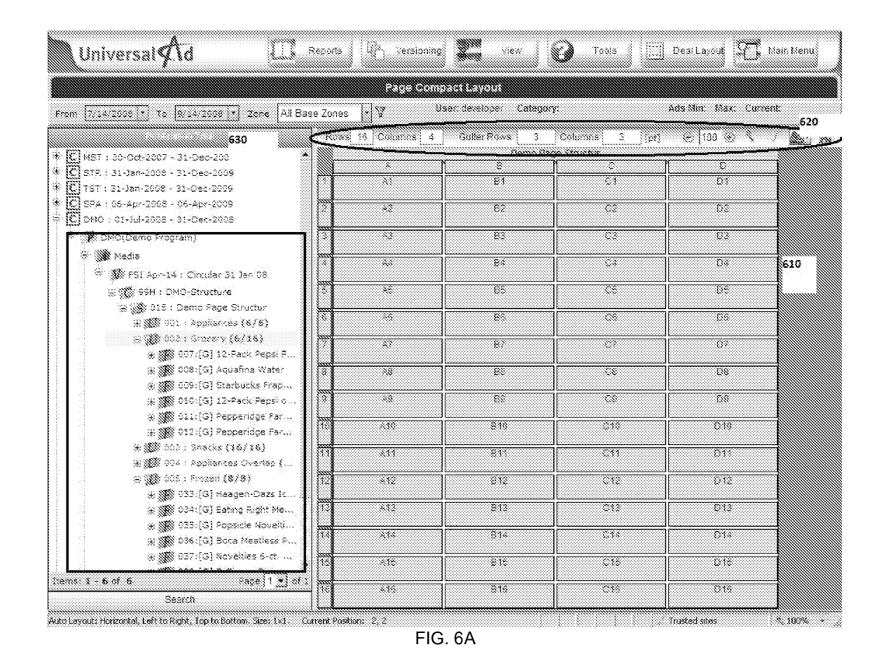

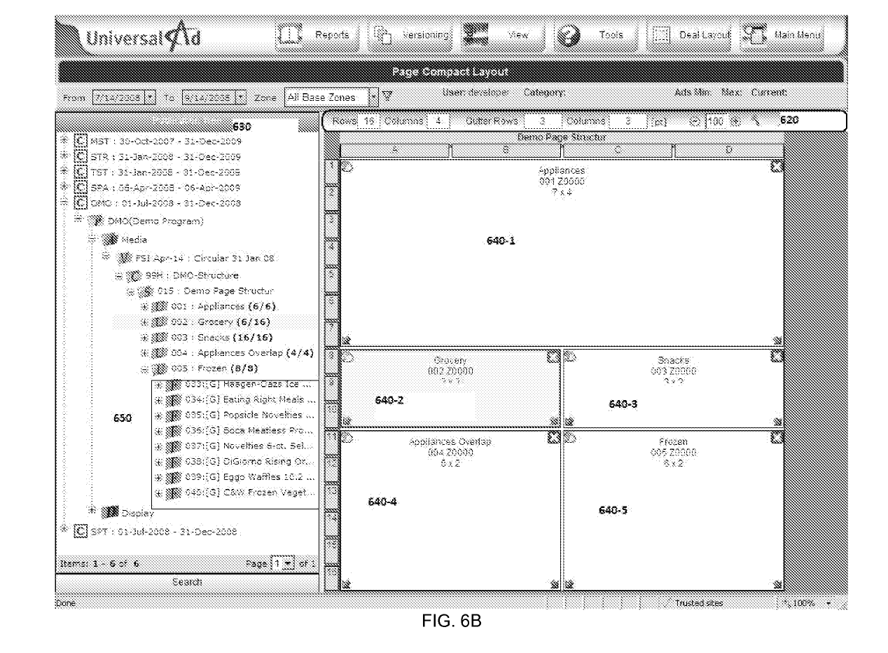

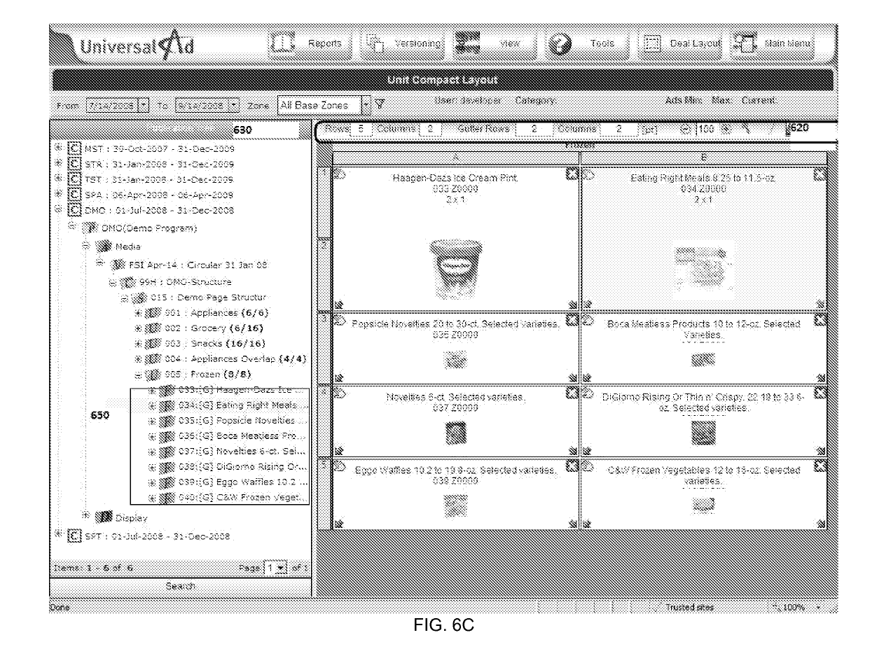

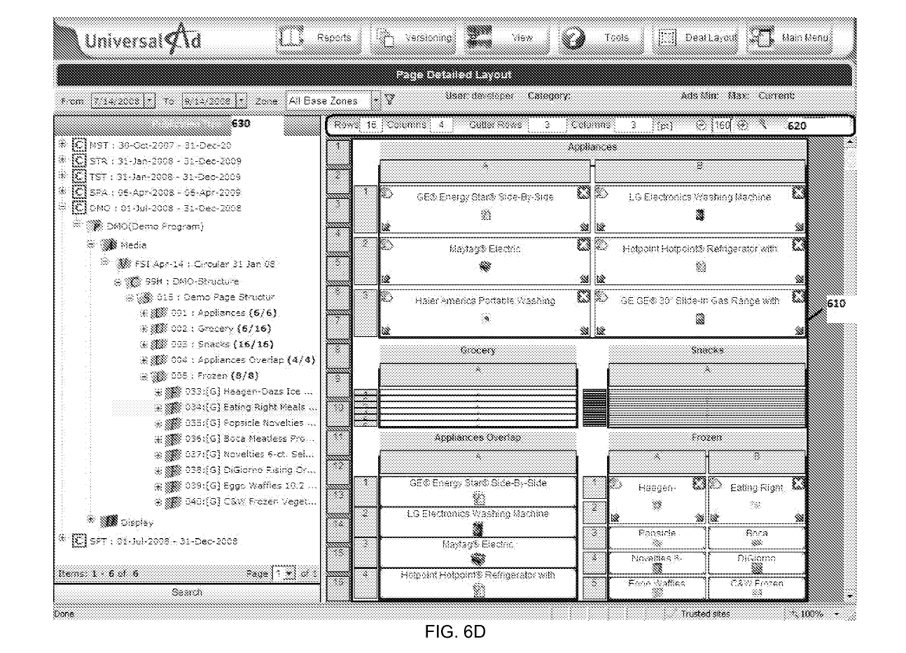

The GUI 550 is rendered by the processor 510 to provide the user with views of pages and sub-page layouts, content units and properties. FIGS. 6A through 6D are exemplary screenshots generated by the GUI 550. FIG. 6A shows a page layout 610 divided into 16 rows and 4 columns. The values of the basic layout parameters for the page 610 are presented in area 620. The user may change the values of these parameters (using the input device 540), thereby causing the generation of a new page layout. The GUI 550 also renders a publication tree 630, which provides an outline of the entire content that will appear on the page. Specifically, the publication tree presents the content units (labeled “U”) and their respective Graphical Elements (labeled “F”). The Graphical Elements of each content unit are placed in a sub-page. As demonstrated in FIG. 6A, the publication tree 630 presents five content units “Appliances”, “Grocery”, “Snacks”, “Appliances Overlap”, and “Frozen”. FIG. 6B shows the sub-pages 640-1 through 640-5 generated for these content units. The internal grid of each sub-page is determined according to the number of Graphical Elements in the content unit. For example, the content unit “Frozen” includes eight Graphical Elements 650 (having serial numbers 033 through 040), thus the respective sub-page 640-5 includes eight cells. This is further illustrated in FIG. 6C. The sub-page “Frozen” is defined using 5 rows and 2 columns where the row gutter and the column gutter is 2 pt wide. These properties are shown in section 620. A layout that includes the mapping of all the Graphical Elements to their respective sub-pages is provided in FIG. 6D.

It would be apparent to one of ordinary skill in the art that the invention disclosed herein can be utilized to layout pages for retail ads. Such pages may be in the form or part of any of free-standing-inserts, flyers, coupons sheets, catalogs, magazines, newspapers, store signs, web pages, mobile phone pages, and so on. These retail ads are product and sales oriented, and they consist of images, graphics, promotional details, logos, prices and other marketing-related information. Furthermore, one of ordinary skill in the art can easily adapt the disclosed teachings herein to create a page layout based on sub-pages for any type of printed or electronic publications including, but not limited to, inserts, flyers, coupons-sheet, catalogs, magazines, newspapers, web-pages, mobile phone pages, and so on.

The foregoing detailed description has set forth a few of the many forms that the invention can take. It is intended that the foregoing detailed description be understood as an illustration of selected forms that the invention can take and not as a limitation to the definition of the invention. It is only the claims, including all equivalents that are intended to define the scope of this invention.

Most preferably, the principles of the invention are implemented as any combination of hardware, firmware and software. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

What we claim is:

1. A method for automatically laying out a page, comprising:
defining a page body area for the page and a page internal grid for the page body area;
positioning a plurality of sub-pages on the page body area according to the page internal grid;
for each sub-page of the plurality of sub-pages defining a sub-page body area for the sub-page and a sub-page internal grid for the sub-page body area, wherein the sub-page internal grid defined for each sub-page and the page internal grid enable to layout the each sub-page independently of the page; and
positioning at least one graphical element on the sub-page body area according to the sub-page internal grid.

2. The method of claim 1, wherein the page being laid out can be printed, saved in a storage device, or uploaded to a web-site.

3. The method of claim 1, further comprising defining a set of creative rules for each of the plurality of sub-pages.

4. The method of claim 1, wherein defining the page internal grid further comprising:
determining internal grid elements, wherein the internal grid elements include at least one of a column gutter, a row gutter, a number of columns, and a number of rows.

5. The method of claim 4, further comprising:
determining elements of the page, wherein the elements of the page include at least one of: a header, a footer, the internal grid elements, a page's height, a page's width, a top margin, a bottom margin, a left margin, and a right margin.

6. The method of claim 1, wherein defining the sub-page internal grid further comprising:
determining elements of the sub-page internal grid, wherein the elements of the sub-page internal grid include at least one of: an internal column gutter, an internal row gutter, a number of internal columns, and number of internal rows.

7. The method of claim 6, further comprising:
determining elements of the sub-page, wherein the elements of the sub-page include at least one of: a header, a footer, a top margin, a bottom margin, a left margin, and a right margin, the sub-page internal grid elements, a sub-page's height, a sub-page's width, and a sub-page top left position.

8. The method of claim 1, wherein positioning the plurality of sub-pages on the page body area, further comprising:
determining a position of a reference point on the sub-page, wherein the reference point is determined by a row position and a column position on the page internal grid; and
sizing the sub-page by determining the number of rows and the number of columns that the sub-page span on the page internal grid.

9. The method of claim 6, wherein positioning plurality of graphical elements on the sub-page body area further comprising:
determining a position of a reference point for each of the plurality of graphical elements, wherein the reference point is determined by a row position and a column position on the sub-page internal grid; and
sizing each of the plurality of the graphical elements by determining the number of rows and the number of columns that the graphical element span on the sub-page internal grid.

10. The method of claim 9, wherein each of the graphical elements comprises at least graphical content in the form of at least one of text and images.

11. The method of claim 10, wherein a graphical element is part of a content unit, wherein the content unit includes all graphical elements to be positioned in a sub-page.

12. The method of claim 1, further comprising:
upon changing the size of the page body area, automatically re-positioning and re-sizing each of the plurality of sup-pages and the plurality of graphical elements positioned on the plurality on the sub-pages.

13. The method of claim 1, further comprising:
assigning elements of a sub-page and elements of a page with at least one of: resizing rules, repurposing rules, interaction rules, and content rules.

14. The method of claim 2, wherein the complete page layout is of at least a retail ad, wherein the retail ad is in the form or part of at least a free standing insert, a flyer, a coupons sheet, a catalog, a magazine, a newspaper, a store sign, a web page and a mobile phone page.

15. A computer readable medium having stored thereon computer executable code causing a compute to execute a process of automatically laying out a page, comprising:
defining a page body area for the page and a page internal grid for the page body area;
positioning a plurality of sub-pages on the page body area according to the page internal grid;
for each sub-page of the plurality of sub-pages defining a sub-page body area for the sub-page and a sub-page internal grid for the sub-page body area, wherein the sub-page internal grid defined for each sub-page and the page internal grid enable to layout the each sub-page independently of the page; and
positioning at least one graphical element on the sub-page body area according to the sub-page internal grid.

16. A system comprising:
a memory for saving design settings;
a storage device for storing at least content units;
a graphical user interface for providing layout views; and
a processor for executing a process of automatically laying out a page, wherein
the process comprising:
defining a page body area for the page and a page internal grid for the page body area;
positioning a plurality of sub-pages on the page body area according to the page internal grid;
for each sub-page of the plurality of sub-pages defining a sub-page body area for the sub-page and a sub-page internal grid for the sub-page body area, wherein the sub-page internal grid defined for each sub-page and the page internal grid allows to layout the each sub-page independently of the page; and
positioning at least one graphical element on the sub-page body area according to the sub-page internal grid.

17. The system of claim 16, wherein the content units include all graphical elements to be placed in a sub-page.
